(19) United States
(12) Patent Application Publication
(10) Pub. No.: US 2011/0147406 A1
(43) Pub. Date: Jun. 23, 2011

(54) TWO PIECE DISPENSER

(75) Inventor: Benjamin Grill, Woodland Park, CO (US)

(73) Assignee: STURMAN BG, LLC, Woodland Park, CO (US)

(21) Appl. No.: 12/975,169

(22) Filed: Dec. 21, 2010

Related U.S. Application Data
(60) Provisional application No. 61/288,774, filed on Dec. 21, 2009.

(51) Int. Cl. B67D 7/72

(52) U.S. Cl. 222/1; 222/399

(57) ABSTRACT

A system and method of dispensing a beverage using gas pressure provides a single use bottle that contains the beverage. A single use dispensing valve is coupled to the bottle to seal the beverage in the bottle. A reusable gas pressure regulator is coupled to the dispensing valve. A single use pressurized gas cartridge that provides an amount of gas just sufficient to dispense the beverage contained in the bottle is coupled to the gas pressure regulator with a piercer that pierces the gas cartridge to supply gas with a regulated pressure. The bottle may be made of PET plastic. The dispensing valve may be coupled to a threaded neck on the bottle. The bottle may hold approximately 1.5 gallons of beverage. The gas cartridge may hold approximately 16 grams of CO₂ gas. In some embodiments, a second regulator and gas cartridge may be coupled to the dispensing valve.

### CROSS REFERENCE TO RELATED APPLICATIONS

This application claims the benefit pursuant to 35 U.S.C. 119(e) of U.S. Provisional Application No. 61/288,774, filed Dec. 21, 2009, which application is specifically incorporated herein, in its entirety, by reference.

### BACKGROUND

### Field

Embodiments of the invention relate to the field of beverage dispensers; and more specifically, beverage dispensers with pressure regulators for regulating the gas pressure from gas cartridges to a beverage to be dispensed.

### SUMMARY

In the present invention, a two piece beverage dispenser using gas pressure to dispense the beverage, all gas cartridge and regulator components are separate from fluid contact components. The dispenser head and all flow path components are packaged with a filled bottle or container of beverage. The regulator and cartridge assemblies have a quick connect allowing them to be removed from the dispenser head. Therefore the cartridge and regulator components would be removable for reuse with a new filled bottle and dispenser head, and the used bottle and dispenser head could be disposed of or recycled. The pressurized gas supplied in the cartridge may be carbon dioxide (CO₂₎, such as for use with carbonated soft drinks or beer, or nitrogen (N₂), such as for use with for wine. In some embodiments, two pressurized cartridges may be used to provide a mixture of two gases, such as CO₂ and N₂. When the cartridge and regulator assembly are disconnected after all of the beverage is dispensed, any remaining gas is allowed to escape because the gas cartridge is sized for the beverage container so as to be nearly fully expended when the beverage container is empty.

The primary goal of this concept is to allow for an inexpensive disposable dispenser head for the beer or other beverage contact portion of the dispenser. The result is a dispenser wherein the cartridge components and regulator assembly is a one time cost to the consumer, thus significantly reducing the per beverage container dispenser cost without requiring the consumer to remove, clean and install anything in the beverage of a new (filled) beverage container. Other features and advantages of the present invention will be apparent from the accompanying drawings and from the detailed description that follows below.

### BRIEF DESCRIPTION OF THE DRAWINGS

The invention may best be understood by referring to the following description and accompanying drawings that are used to illustrate embodiments of the invention by way of example and not limitation. In the drawings, in which like reference numerals indicate similar elements:

FIG. 1 is a perspective view of an assembled system for dispensing a beverage using gas pressure.

FIG. 2 is a bottom view of the assembled system of FIG. 1.

FIG. 3 is a perspective view of the system of FIG. 1 as it may be supplied before the pressure regulator is coupled to the dispensing valve.

FIG. 4 is an exploded perspective view of the system of FIG. 1.

FIG. 5 is an exploded perspective view of a portion the system of FIG. 1.

FIG. 6 is a perspective view of an assembled portion the system of FIG. 1.

FIG. 7 is a top view of the assembled portion the system shown in FIG. 5.

FIG. 8 is a cross-section view of the assembled portion the system taken along section line 8-8 of FIG. 7.

FIG. 9 is a perspective view of another assembled system for dispensing a beverage using gas pressure.

FIG. 10 is a top view of a portion of the system shown in FIG. 9.

FIG. 11 is a cross-section view of the assembled portion the system taken along section line 11-11 of FIG. 10.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

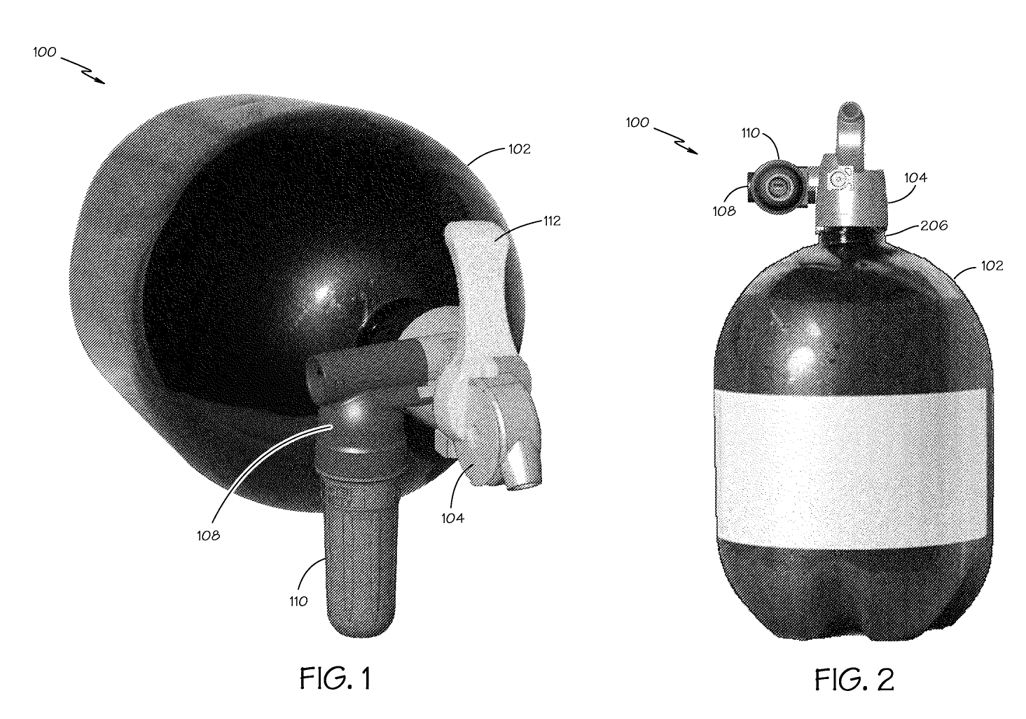

FIG. 1 shows a perspective view of an assembled system 100 for dispensing a beverage using gas pressure. FIG. 2 shows a bottom view of the assembled system 100. A single use bottle 102 contains the beverage, which may be a carbonated beverage such as a carbonated soft drink or beer or a still beverage such as fruit juice or wine. The bottle 102 may hold approximately 1.5 gallons (5.7 liters) of beverage. The bottle 102 may be made of a plastic material, such as polyethylene terephthalate (PET) plastic, or it may be a metal container, such as steel or aluminum.

A single use dispensing valve 104 is coupled to the bottle 102 to seal the beverage in the bottle. The bottle 102 may include a threaded neck 206 (FIG. 2) and the single use dispensing valve 104 may be coupled to the threaded neck. A movable handle 112 is provided to open and close the dispensing valve 104.

A reusable gas pressure regulator 108 is coupled to the dispensing valve 104. A single use pressurized gas cartridge that provides an amount of gas just sufficient to dispense the beverage contained in the bottle is coupled to the gas pressure regulator 108. For example, a cartridge containing approximately 16 grams of CO₂ gas may be just sufficient to dispense approximately 1.5 gallons (5.7 liters) of beverage. For the purposes of this invention, “just sufficient” means that there is a sufficient amount of gas to fully dispense all of the beverage in the bottle and that there will be only a small amount of gas remaining to be vented afterward. The pressurized gas supplied in the cartridge may be carbon dioxide (CO₂₎, such as for use with carbonated soft drinks or beer, or nitrogen (N₂), such as for use with for wine. In some embodiments, two pressurized cartridges may be used to provide a mixture of two gases, such as CO₂ and N₂.

The gas cartridge is enclosed by a cartridge holder 110 that screws onto the gas pressure regulator 108. As the cartridge holder 110 is screwed onto the gas pressure regulator 108, the gas cartridge is pressed into a piercer. The piercer pierces the gas cartridge to couple the cartridge to the gas pressure regulator and thereby supply the bottle with gas from the cartridge at a regulated pressure. The gas may be regulated to a pressure of 15 to 20 pounds per square inch [psi] (100 to 140 kilopascal [kPa]) by the regulator. The threads of the cartridge holder 110 engage the regulator 108 before the piercer engages the cartridge so that the cartridge holder can retain the cartridge if there is gas to be vented when the cartridge is removed after all the beverage has been dispensed.

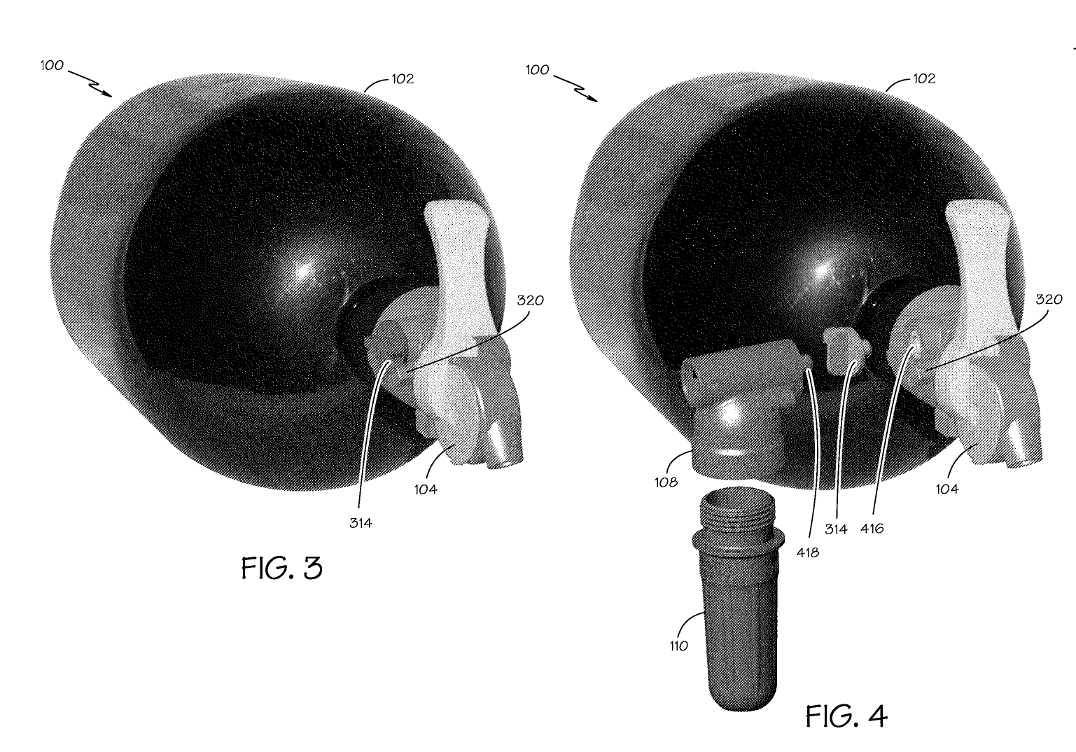

FIG. 3 shows a perspective view of the system 100 as it may be supplied before the pressure regulator is coupled to the dispensing valve 104. A single use plug 314 may be provided to seal the coupling 416 (FIG. 4) on the dispensing valve 104 that will receive the reusable gas pressure regulator. The primary purpose of the plug 314 is to maintain cleanliness of the coupling and the interior of the dispensing valve prior to the installation of the pressure regulator. The plug may also provide a secondary seal to prevent loss of pressure in the bottle prior to the installation of the pressure regulator. The dispensing valve 104 may include a latching lip 320 that engages the plug 314 or the regulator 108 when they are coupled to the valve. The latching lip 320 may be configured so that the plug 314 or the regulator 108 have to be turned approximately 90 degrees to engage the latching lip.

FIG. 4 shows an exploded perspective view of the system 100. As suggested by this view, the plug 314 is removed from the coupling 416 on the dispensing valve 104. A coupling 418 on the regulator 108 is coupled to the coupling in place of the plug. The latching lip 320 may be further configured so that the regulator 108 has to be turned such that the cartridge cover 110 turns toward the bottle 102 to disengage the regulator from the latching lip 320. Referring to FIG. 2, it may be appreciated that the bottle 102 may prevent the regulator 108 from turning freely toward the bottle if the cartridge cover 110 is coupled to the regulator. This provides an interlock that makes it difficult to remove or install the regulator 108 with the cartridge cover 110 coupled to the regulator. Thus the sequence for installing a gas cartridge requires assembling the regulator 108 to the dispensing valve 104 before connecting the gas cartridge. Likewise, the gas cartridge needs to be removed from the regulator 108 before the regulator is removed from the dispensing valve 104.

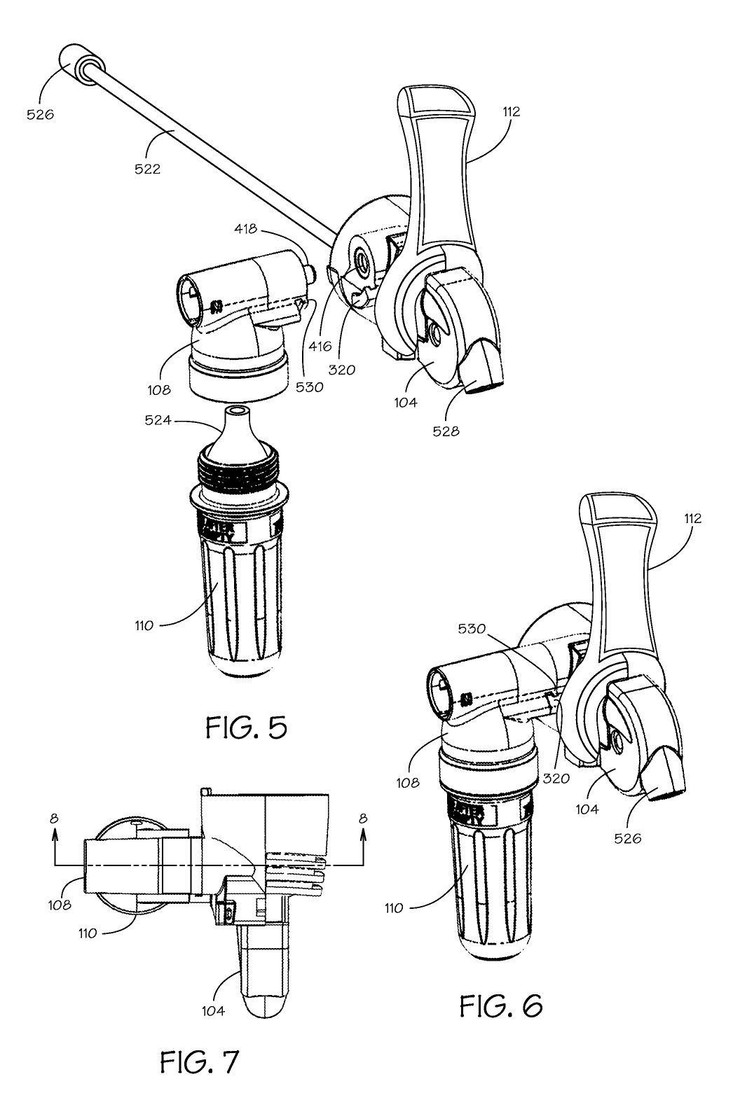

FIG. 5 shows an exploded perspective view of the dispensing valve 104, the regulator 108, and the cartridge cover 110 removed from the bottle. A flexible tube 522 with a weighted end 526 is coupled to the dispensing valve 104 to deliver the beverage from the bottle to the dispensing spout 528 of the valve when the handle 112 is moved to the on position. It will be seen that the top of the gas cartridge 524 projects above the cartridge cover 110 so that the end of the gas cartridge can be pierced by the piercer in the regulator 108.

FIG. 6 shows a perspective view of the dispensing valve 104, the regulator 108, and the cartridge cover 110 in an assembled configuration.

FIG. 7 shows a top view of the dispensing valve 104 without the handle, the regulator 108, and the cartridge cover 110 in an assembled configuration.

FIG. 8 shows a cross-section of the dispensing valve 104, the regulator 108, the cartridge cover 110, and the gas cartridge 524 taken along section line 8-8 of FIG. 7. In the embodiment illustrated the single use dispensing valve 104 includes a quick connect coupling 416 to receive a mating coupling 418 of the reusable gas pressure regulator 108. A resilient seal 832, such as an O-ring, provides a gas tight seal in the coupling. The seal 832 may be assembled with the single use dispensing valve 104 so that a new seal is used each time the reusable gas pressure regulator 108 is coupled to the valve. A one-way valve 834, such as a duck bill valve, allows pressurized gas from the regulator 108 to flow into the bottle through the dispensing valve 104 and prevents a loss of bottle pressure if the quick connect coupling 416 is open. The one-way valve 834 is replaced after the beverage is dispensed since it is assembled with the single use dispensing valve 104. This eliminates the need to clean the one-way valve 834 after it has come in contact with the beverage as it is dispensed.

The locking lip 320 and the mating portion 530 of the regulator 108 can be seen in FIG. 8. It will be appreciated that the pressure of the gas creates a force that tends to push the regulator 108 away from the dispensing valve 104. The locking lip 320 retains the regulator 108 in the quick connect coupling 416 of the dispensing valve 104. The locking lip 320 and/or the mating portion 530 of the regulator 108 may be configured so that the regulator must be connected to the dispensing valve 104 before the cartridge cover 110 is coupled to the regulator. This may be accomplished by configuring the locking lip 320 and/or the mating portion 530 so that the regulator has to be oriented so that the cartridge cover 110 would be directed toward the bottle to insert the regulator in the valve. Interference between the bottle and the cartridge cover 110 in this orientation prevents insertion of the regulator in the valve. After the regulator is turned to engage the locking lip 320 the cartridge cover 110 can be installed without interfering with the bottle.

When the regulator 108 has been coupled to the dispensing valve 104, the cartridge cover 110 is screwed onto the regulator. This presses a single use gas cartridge 524 into a piercer 838 included with the regulator to allow gas to flow from the cartridge into the regulator. A resilient seal 836 provides a gas tight connection between the gas cartridge 524 and the regulator 108.

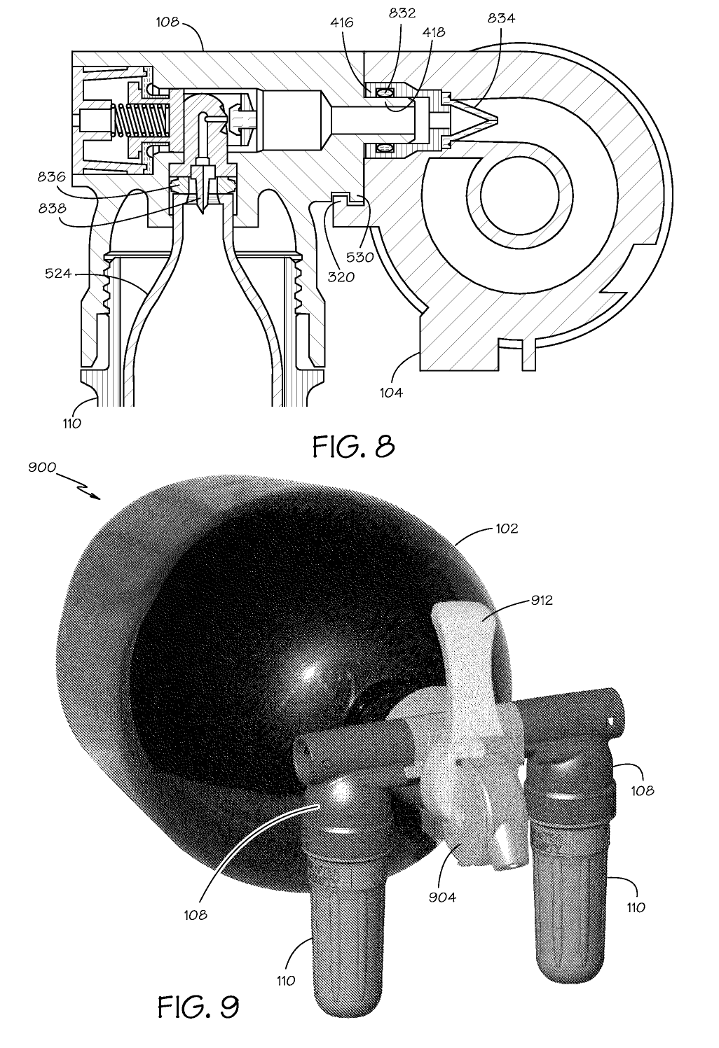

FIG. 9 shows another embodiment of a single use dispensing valve 904 that provides connections for two reusable gas pressure regulators 108. This permits the use of two gas cartridges, which may supply a greater quantity of gas or two different gases, such as CO₂ and N₂. The reusable regulator 108 and cartridge cover 110 may be the same as used in the previously described single cartridge embodiment. Thus, the same reusable devices may be used with either embodiment of the dispensing valve.

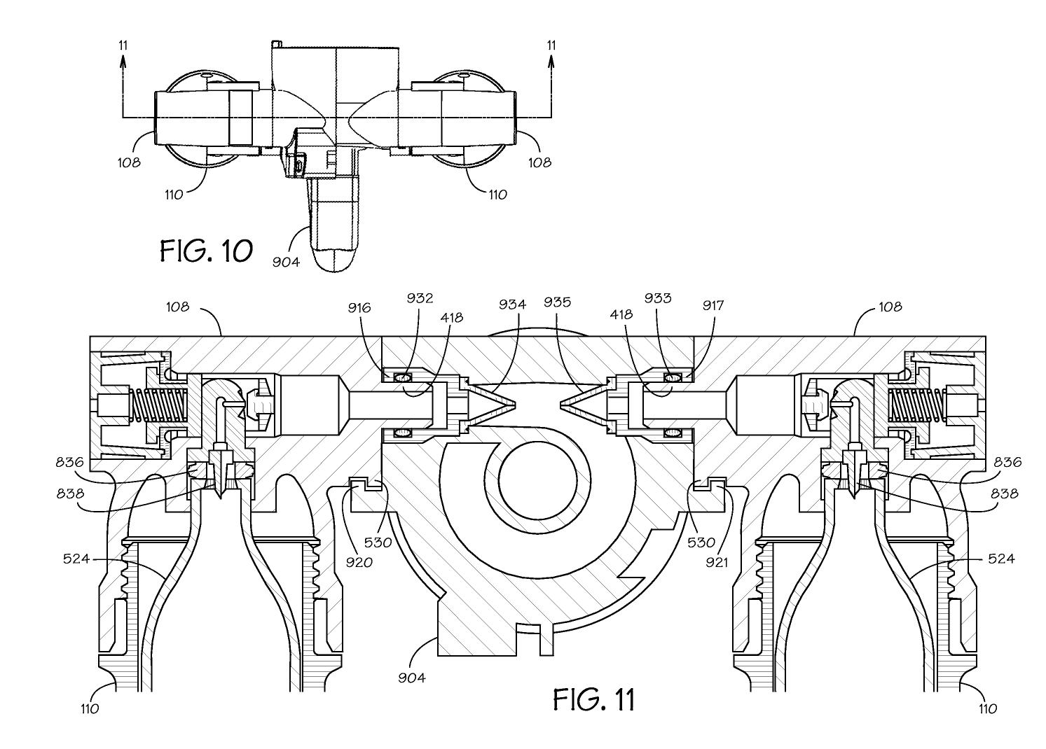

FIG. 10 shows a top view of the dispensing valve 904 without the handle, the two regulators 108, and cartridge covers 110 in an assembled configuration.

FIG. 11 shows a cross-section of the dispensing valve 904, the two regulators 108, the cartridge covers 110, and the gas cartridges 524 taken along section line 11-11 of FIG. 10. In the embodiment illustrated, the single use dispensing valve 904 includes two quick connect couplings 916, 917 to receive mating couplings 418 of the reusable gas pressure regulators 108. The quick connect couplings 916, 917 may be configured to receive the same regulators 108 as used in the previously described embodiment.

The locking lips 920, 921 may be mirror images of one another. Thus each regulator has to be oriented so that the cartridge cover 110 would be directed toward the bottle to insert the regulator in the valve. Interference between the bottle and the cartridge cover 110 in this orientation prevents insertion of the regulator in the valve. After the regulator is turned to engage the locking lip 320 the cartridge cover 110 can be installed without interfering with the bottle. It will be appreciated that the regulators will be rotated in opposite directions to engage the locking lips. Facing the bottle, the regulator on the left side is rotated counter-clockwise to engage the left locking lip 920. The regulator on the right side is rotated clockwise to engage the right locking lip 921.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other modifications may occur to those of ordinary skill in the art. The description is thus to be regarded as illustrative instead of limiting.

What is claimed is:

1. A method of dispensing a beverage using gas pressure, the method comprising:
providing a single use bottle that contains the beverage;
providing a single use dispensing valve coupled to the bottle to seal the beverage in the bottle;
providing a single use pressurized gas cartridge that provides an amount of gas just sufficient to dispense the beverage contained in the bottle;
coupling a reusable gas pressure regulator to the dispensing valve; and
coupling the gas cartridge to the gas pressure regulator with a piercer that pierces the gas cartridge to supply gas to the bottle with a regulated pressure.

2. The method of claim 1 wherein the single use bottle is made of plastic.

3. The method of claim 1 wherein the single use bottle is made of polyethylene terephthalate (PET) plastic.

4. The method of claim 1 wherein the single use bottle includes a threaded neck and the single use dispensing valve is coupled to the threaded neck.

5. The method of claim 1 wherein the single use bottle holds approximately 1.5 gallons (5.7 liters) of beverage.

6. The method of claim 5 wherein the single use pressurized gas cartridge holds approximately 16 grams of gas.

7. The method of claim 1 wherein the single use pressurized gas cartridge provides carbon dioxide (CO₂).

8. The method of claim 1 wherein the single use pressurized gas cartridge provides nitrogen (N₂).

9. The method of claim 1 wherein the single use dispensing valve includes a quick connect coupling to receive the reusable gas pressure regulator.

10. The method of claim 9 wherein the quick connect coupling in the single use dispensing valve includes a single use resilient seal that seals the connection to the reusable gas pressure regulator.

11. The method of claim 9 wherein the quick connect coupling in the single use dispensing valve includes a single use one way valve to retain pressure in the single use bottle.

12. The method of claim 9 further including:
providing a single use plug to seal the quick connect coupling; and
removing the single use plug prior to coupling the reusable gas pressure regulator to the dispensing valve.

13. The method of claim 9 wherein the single use dispensing valve includes a second quick connect coupling to receive a second reusable gas pressure regulator and the method further includes coupling a second single use pressurized gas cartridge to the second gas pressure regulator with a second piercer that pierces the second gas cartridge to supply a second gas to the bottle with a regulated pressure.

14. The method of claim 12 wherein the second gas is nitrogen (N₂).

15. A system for dispensing a beverage using gas pressure, the system comprising:
a single use bottle that contains the beverage;
a single use dispensing valve coupled to the bottle to seal the beverage in the bottle;
a single use pressurized gas cartridge that provides an amount of gas just sufficient to dispense the beverage contained in the bottle;
a reusable gas pressure regulator coupled to the dispensing valve; and
a piercer that pierces the gas cartridge to couple the gas cartridge to the gas pressure regulator and supply gas to the bottle with a regulated pressure.

16. The system of claim 15 wherein the single use bottle is made of metal.

17. The system of claim 15 wherein the single use bottle is made of polyethylene terephthalate (PET) plastic.

18. The system of claim 15 wherein the single use bottle includes a threaded neck and the single use dispensing valve is coupled to the threaded neck.

19. The system of claim 15 wherein the single use bottle holds approximately 1.5 gallons (5.7 liters) of beverage and the single use pressurized gas cartridge holds approximately 16 grams of gas.

20. The system of claim 15 wherein the single use dispensing valve includes a quick connect coupling to receive the reusable gas pressure regulator.

21. The system of claim 20 wherein the quick connect coupling in the single use dispensing valve includes a single use resilient seal that seals the connection to the reusable gas pressure regulator.

22. The system of claim 20 wherein the quick connect coupling in the single use dispensing valve includes a single use one way valve to retain pressure in the single use bottle.

23. The system of claim 20 further including a single use plug to seal the quick connect coupling.

24. The system of claim 20 wherein the single use dispensing valve includes a second quick connect coupling to receive a second reusable gas pressure regulator.
